(19) United States
(12) Patent Application Publication
(10) Pub. No.: US 2005/0069807 A1
(43) Pub. Date: Mar. 31, 2005

(54) Photoresist composition

(75) Inventor: Jae Chang Jung, Seoul (KR)

Correspondence Address: MARSHALL, GERSTEIN & BORUN LLP, 6300 SEARS TOWER, 233 S. WACKER DRIVE, CHICAGO, IL, 60606, US

(73) Assignee: HYNIX SEMICONDUCTOR INC., Gyeonggi-do (KR)

(21) Appl. No.: 10/875,984

(22) Filed: Jun. 24, 2004

(30) Foreign Application Priority Data
Sep. 29, 2003 (KR) 10-2003-0067497

(51) Int. Cl. G03C 1/76

(52) U.S. Cl. 430/270.1

(57) ABSTRACT

Disclosed herein are photoresist compositions, methods of forming photoresist patterns using the compositions, and semiconductor devices made by the methods. The negative photoresist composition includes a photoresist polymer having a polymerization repeating unit and a melamine derivative as a cross-linking agent, which prevents the collapse of photoresist patterns formed at a thickness of less than 50 nanometers (nm). Accordingly, the disclosed negative photoresist compositions are useful in a photolithography process, especially in those processes using EUV (Extreme Ultraviolet, 13 nanometers).

### BACKGROUND

1. Technical Field

The present invention relates to photoresist compositions. More specifically, it relates to photoresist polymers and photoresist compositions comprising the same, which are suitable for a photolithography process using a light source of a far ultraviolet region such as EUV (Extreme Ultraviolet, 13 nanometers) in fabrication of microfine circuits of a high-integrated semiconductor device.

2. Description of the Related Art

Recently, chemical amplification type DUV photoresists have been investigated in order to achieve high sensitivity in microfine circuit formation processes for preparing semiconductor devices. Such photoresists are prepared by mixing a photoacid generator and a matrix polymer having an acid labile structure.

According to reaction mechanism of such a photoresist, the photoacid generator produces acid when it is illuminated by a light source, and the main chain or branched chain of the matrix polymer reacts with the generated acid in the baking process and is decomposed or crosslinked, so that polarity of the polymer is considerably altered. This alteration of polarity results in a solubility difference in a developing solution between an exposed area and an unexposed area. For example, in case of a negative photoresist, acid is generated in the exposed area and the main or branched chain of the polymer causes cross-linking reaction by the generated acid and becomes insoluble. As a result, the polymer is not dissolved in a subsequent development process, thereby forming a negative image of a mask on a substrate.

In the photolithography process, resolution depends upon wavelength of a light source. As the wavelength of light source becomes smaller, the more microfine patterns may be formed. For exposure equipment required for pattern formation of less than 50 nanometers (nm), Extreme Ultraviolet (EUV) equipment is under development, and photoresist materials are also under development. For the photoresists, there is a significant problem that pattern collapse may occur in formation of the photoresist pattern having a thickness of less than 50 nm. Therefore, negative photoresists are required rather than positive photoresists to prevent collapse of photoresist patterns.

### SUMMARY OF THE DISCLOSURE

Accordingly, negative photoresist compositions are disclosed which are useful for a photolithography process using EUV to form less than 50 nm microfine patterns. Specifically, disclosed herein is a photoresist composition comprising a photoresist polymer including a polymerization repeating unit represented by Formula 1, a cross-linking agent represented by Formula 2, a photoacid generator and an organic solvent: 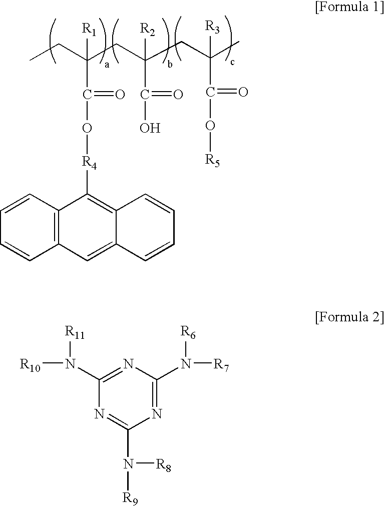
R₁, R₂ and R₃ are individually hydrogen or a methyl group;
R₄ is a linear or branched C₁-C₁₀ alkylene group;
R₅ is an acid labile protecting group;
R₆, R₇, R₈, R₉, R₁₀, and R₁₁ are individually a linear or branched C₁-C₁₀ alkyl or C₁-C₁₀ alkoxy group; and
a:b:c=30-60 mol %:20-50 mol %:5-30 mol %.

Processes for forming a photoresist pattern by using the above-mentioned photoresist composition are also disclosed. One such process includes the steps of coating the photoresist composition on a wafer to form a photoresist film, exposing the photoresist film to light, and developing the exposed film to a photoresist pattern.

Semiconductor devices produced by using the above-mentioned photoresist compositions are also disclosed.

### BRIEF DESCRIPTION OF THE DRAWINGS

FIG. 1 is a NMR spectrum of a photoresist polymer according to the present invention.

FIG. 2 is a photograph illustrating a photoresist pattern formed by using a photoresist composition of the present invention.

### DETAILED DESCRIPTION OF THE PRESENT INVENTION

The present invention provides a negative photoresist composition comprising a photoresist polymer including a polymerization repeating unit represented by Formula 1; a cross-linking agent represented by Formula 2; a photoacid generator; and an organic solvent.

In the photoresist composition, a melamine derivative is present in an amount ranging from 5 weight per cent (wt %) to 30 wt % based on the weight of the photoresist polymer as a cross-linking agent. 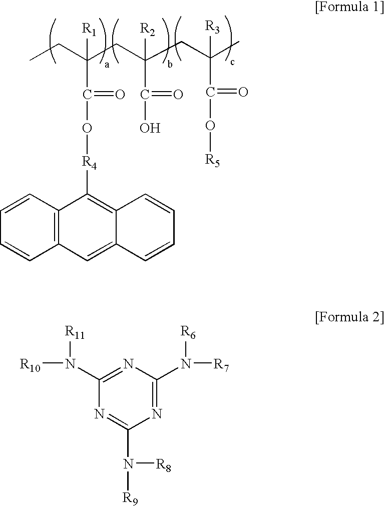
wherein
R₁, R₂ and R₃ are individually hydrogen or a methyl group;
R₄ is a linear or branched C₁-C₁₀ alkylene group;
R₅ is an acid labile protecting group;
R₆, R₇, R₈, R₉, R₁₀, and R₁₁ are individually a linear or branched C₁-C₁₀ alkyl or C₁-C₁₀ alkoxy group; and
a:b:c=30-60 mol %:20-50 mol %:5-30 mol %.

The acid labile protecting group is a group which may be separated by acid. The group prevents the photoresist compound from dissolving in an alkaline developing solution. If the acid labile protecting group is separated by acid generated by the light exposure, the photoresist compound may be dissolved in the alkaline solution.

The acid labile protecting group can be any of the known protective groups including, for example, the conventional acid labile protecting groups disclosed in U.S. Pat. No. 5,212,043 (May 18, 1993), WO 97/33198 (Sep. 12, 1997), WO 96/37526 (Nov. 28, 1996), EP 0 794 458 (Sep. 10, 1997), EP 0 789 278 (Aug. 13, 1997), U.S. Pat. No. 5,750,680 (May 12, 1998), U.S. Pat. No. 6,051,678 (Apr. 18, 2000), GB 2,345,286 A (Jul. 5, 2000), U.S. Pat. No. 6,132,926 (Oct. 17, 2000), U.S. Pat. No. 6,143,463 (Nov. 7, 2000), U.S. Pat. No. 6,150,069 (Nov. 21, 2000), U.S. Pat. No. 6,180,316 B1 (Jan. 30, 2001), U.S. Pat. No. 6,225,020 B1 (May 1, 2001), U.S. Pat. No. 6,235,448 B1 (May 22, 2001), and U.S. Pat. No. 6,235,447 B1 (May 22, 2001). Preferably, the acid labile protecting group can be selected from the group consisting of t-butyl, tetrahydropyran-2-yl, 2-methyl tetrahydrophyran-2-yl, tetrahydrofuran-2-yl, 2-methyl tetrahydrofuran-2-yl, 1-methoxyprophyl, 1-methoxy-1-methylethyl, 1-ethoxypropyl, 1-ethoxy-1-methylethyl, 1-methoxyethyl, 1-ethoxyethyl, t-butoxyethyl, 1-isobutoxyethyl and 2-acetylmenth-1-yl and 2-methyl adamantyl.

The polymerization repeating unit of Formula 1 includes an anthracene monomer having excellent etching resistance.

Preferably, the polymerization repeating unit of Formula 1 is poly(9-anthracene methyl methacrylate/methylmethacrylate/acrylic acid) and the melamine derivative of the Formula 2 can preferably be selected from the compounds of Formula 2a or 2b.

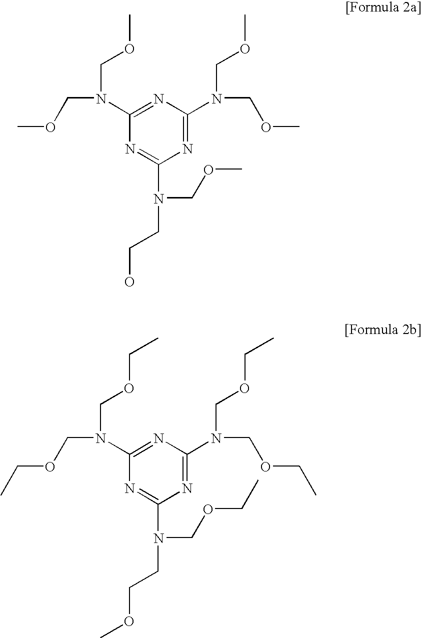

The photoresist composition of the present invention further comprises an organic solvent and a photoacid generator in addition to the photoresist polymer and the cross-linking agent.

Any conventional photoacid generators capable of producing acid by the light exposure can be used, which includes some of conventional photoacid generators disclosed in U.S. Pat. No. 5,212,043 (May 18, 1993), WO 97/33198 (Sep. 12, 1997), WO 96/37526 (Nov. 28, 1996), EP 0 794 458 (Sep. 10, 1997), EP 0 789 278 (Aug. 13, 1997), U.S. Pat. No. 5,750,680 (May 12, 1998), U.S. Pat. No. 6,051,678 (Apr. 18, 2000), GB 2,345,286 A (Jul. 5, 2000), U.S. Pat. No. 6,132,926 (Oct. 17, 2000), U.S. Pat. No. 6,143,463 (Nov. 7, 2000), U.S. Pat. No. 6,150,069 (Nov. 21, 2000), U.S. Pat. No. 6,180,316 B1 (Jan. 30, 2001), U.S. Pat. No. 6,225,020 B1 (May 1, 2001), U.S. Pat. No. 6,235,448 B1 (May 22, 2001), and U.S. Pat. No. 6,235,447 B1 (May 22, 2001). Sulfide type or onium type compounds are mostly preferred for the photoacid generator.

The photoacid generator can be one or more compounds selected from the group consisting of diphenyl iodide hexafluorophosphate, diphenyl iodide hexafluoroarsenate, diphenyl iodide hexafluoroantimonate, diphenyl p-methoxyphenylsulfonium triflate, diphenyl p-toluenylsulfonium triflate, diphenyl p-isobutylphenylsulfonium triflate, diphenyl p-t-butylphenylsulfonium triflate, triphenylsulfonium hexafluorophosphate, triphenylsulfonium hexafluoroarsenate, triphenylsulfonium hexafluoroantimonate, triphenylsulfonium triflate, dibutylnaphthylsulfonium triflate, phthalimidotrifluoromethane sulfonate, dinitrobenzyltosylate, n-decyl disulfone, and naphthylimido trifluoromethane sulfonate. Here, the photoacid generator is preferably present in an amount ranging from 2 wt % to 10 wt % based on the weight of the photoresist polymer. It has been found that the photoacid generator lowers photosensitivity of the photoresist composition when used in the amount of less than 2 wt %. However, when used in the amount of more than 10 wt %, the photoacid generator absorbs far ultraviolet rays and generates a large amount of acid, resulting in formation of a pattern with poor profile.

Any of conventional organic solvent can be used in the photoresist composition, including some of the conventional solvents disclosed in the documents described above. Preferably, the organic solvent is selected from the group consisting of methyl 3-methoxypropionate, ethyl 3-ethoxypropionate, propyleneglycol methylether acetate, cyclohexanone, 2-heptanone, ethyl lactate, and mixtures thereof. Here, the organic solvent is present in an amount ranging from 700 wt % to 4000 wt % based on the weight of the photoresist polymer to obtain a photoresist film having a desired thickness.

The present invention also provides a process for photoresist pattern formation, which includes the steps of coating the photoresist composition of the present invention on a top portion of an underlying layer to form a photoresist film, exposing the photoresist film to light, and developing the exposed film to form a photoresist pattern.

The process for forming a photoresist pattern can also include the steps of performing a soft-baking step before the photoresist film is exposed to light and a post-baking step after the photoresist film is exposed to light. Preferably, the baking step is performed at a temperature ranging from 70° C. to 200° C.

The exposure process is preferably performed by using a light source selected from the group consisting of EUV, KrF, ArF, VUV, E-beam, X-beam, and ion beam.

The developing process can be performed using alkaline developing solution. TMAH aqueous solution ranging from 0.01 wt % to 5 wt % can preferably be used.

The reaction mechanism of the negative photoresist according to the present invention is as follows: The photoacid generator produces acid when it is exposed to ultraviolet rays from the light source. In the baking process after exposure, the acid reacts with the polymer comprising the repeating unit of Formula 1 to cause cross-linking reaction by the melamine derivative of Formula 2 as a cross-linking agent. As a result, the polymer can no longer be dissolved in the subsequent developing process. However, since the cross-linking reaction does not occur in the unexposed area, the polymer is dissolved in the subsequent process, thereby forming a negative image of a mask on the substrate.

In addition, the present invention provides a semiconductor device manufactured by the photoresist composition of the present invention.

Hereinafter, the present invention will be described in more detail by the specific examples. However, they are just the examples and are not intended to limit the scope of the present invention.

### EXAMPLE 1

### Preparation of Photoresist Polymer

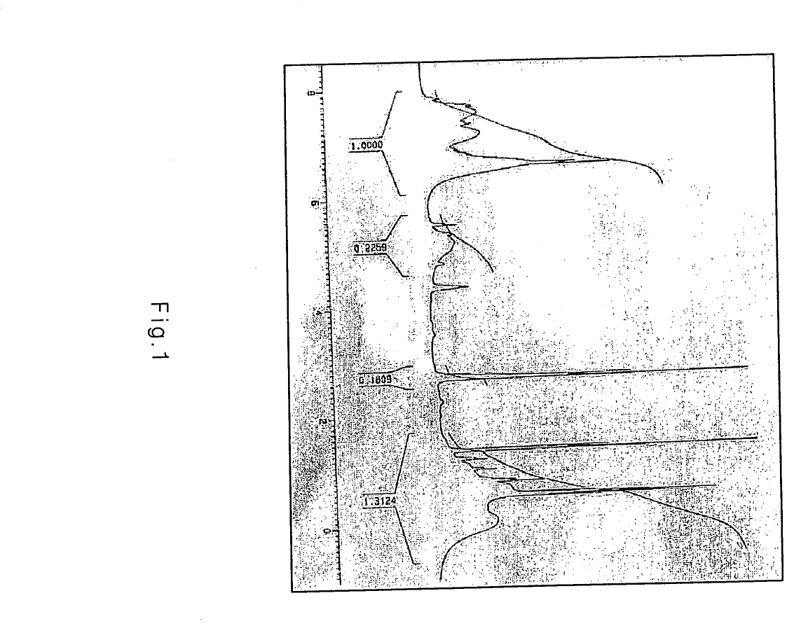

Four grams (g) of 9-anthracene methyl methacrylate, 2 g of methyl methacrylate, 4 g of acrylic acid and 0.2 g of AIBN were dissolved in 50 g of a mixture solvent of 25 g of tetrahydrofuran and 25 g of methylethylketone, and the resulting mixture was reacted at 66° C. for 8 hours. After the reaction, the resulting mixture was precipitated in ethylether, filtered, and vacuum-dried, thereby obtaining poly(9-anthracene methyl methacrylate/methyl methacrylate/acrylic acid) having a molecular weight of 17,500 (yield: 86 %) (see the NMR spectrum of FIG. 1).

### EXAMPLE 2

### Preparation of Negative Photoresist Composition

One gram of poly(9-anthracene methyl methacrylate/methyl methacrylate/acrylic acid) obtained from Example 1, 0.1 g of the melamine derivative of Formula 2a and 0.05 g of triphenylsulfonium trifate as an acid generator were dissolved in 20 g of cyclonehexanone as an organic solvent. The resulting mixture was filtered through a filter with a 0.20 micrometer (μm) pore size, thereby obtaining a photoresist composition of the present invention.

### EXAMPLE 3

### Photoresist Pattern Formation

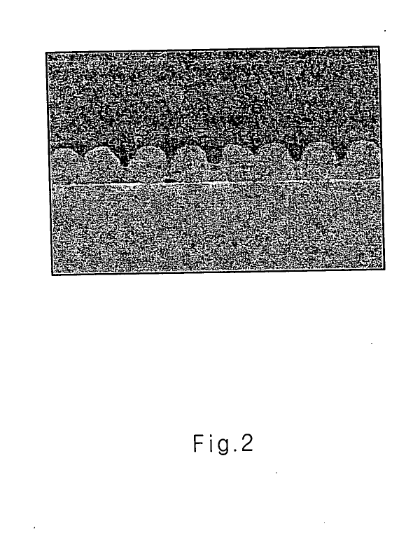

The photoresist composition obtained from Example 2 was spin-coated on a silicon wafer with 0.13 μm thickness, and baked at about 130° C. for 90 seconds. After baking, the photoresist film was exposed to light using an ArF laser exposer (ASML Co., Ltd), and then post-baked at about 130° C. for 90 seconds. When the post-baking was completed, it was developed in a 2.38 wt % TMAH solution for about 40 seconds, to obtain 130 nm L/S pattern without collapse (see FIG. 2).

As discussed hereinbefore, microfine patterns can be obtained by using the negative photoresist composition of the present invention comprising a melamine derivative as a cross-linking agent and a polymer which causes cross-linking reaction by the cross-linking agent. Specifically, the photoresist composition of the present invention is useful for a photolithography process using EUV to form photoresist patterns of less than 50 nm thickness.

1. A photoresist composition comprising a photoresist polymer including a polymerization repeating unit represented by Formula 1, a cross-linking agent represented by Formula 2, a photoacid generator and an organic solvent: 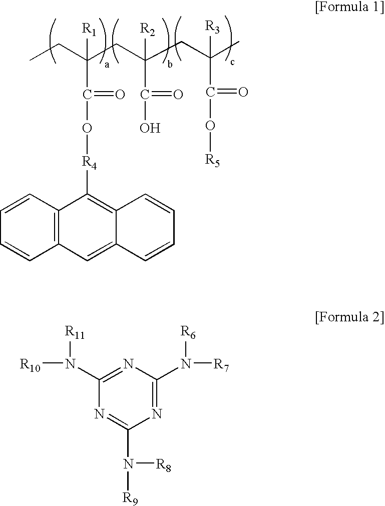
wherein
R₁, R₂ and R₃ are individually hydrogen or a methyl group;
R₄ is a linear or branched C₁-C₁₀ alkylene group;
R₅ is an acid labile protecting group;
R₆, R₇, R₈, R₉, R₁₀, and R₁₁ are individually a linear or branched C₁-C₁₀ alkyl or C₁-C₁₀ alkoxy group; and
a:b:c=30-60 mol %:20-50 mol %:5-30 mol %.

2. The photoresist composition according to claim 1, wherein the cross-linking agent is present in an amount ranging from 5 wt % to 30 wt % based on the weight of the photoresist polymer.

3. The photoresist composition according to claim 1, wherein the acid labile protecting group is selected from the group consisting of t-butyl, tetrahydropyran-2-yl, 2-methyl tetrahydrophyran-2-yl, tetrahydrofuran-2-yl, 2-methyl tetrahydrofuran-2-yl, 1-methoxyprophyl, 1-methoxy-1-methylethyl, 1-ethoxypropyl, 1-ethoxy-1-methylethyl, 1-methoxyethyl, 1-ethoxyethyl, t-butoxyethyl, 1-isobutoxyethyl and 2-acetylmenth-1-yl, and 2-methyl adamantyl.

4. The photoresist composition according to claim 1, wherein the polymerization repeating unit of Formula 1 is poly(9-anthracene methyl methacrylate/methyl methacrylate/acrylic acid) and the cross-linking agent is represented by Formula 2a or 2b:

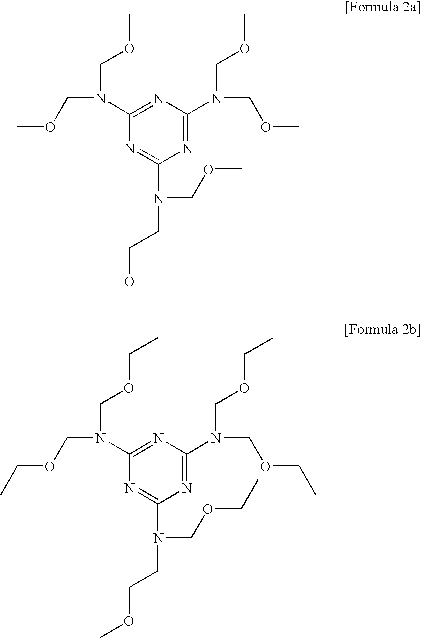

5. The photoresist composition according to claim 1, wherein the photoacid generator is one or more compounds selected from the group consisting of diphenyl iodide hexafluorophosphate, diphenyl iodide hexafluoroarsenate, diphenyl iodide hexafluoroantimonate, diphenyl p-methoxyphenylsulfonium triflate, diphenyl p-toluenylsulfonium triflate, diphenyl p-isobutylphenylsulfonium triflate, diphenyl p-t-butylphenylsulfonium triflate, triphenylsulfonium hexafluorophosphate, triphenylsulfonium hexafluoroarsenate, triphenylsulfonium hexafluoroantimonate, triphenylsulfonium triflate, dibutylnaphthylsulfonium triflate, phthalimidotrifluoromethane sulfonate, dinitrobenzyltosylate, n-decyl disulfone, and naphthylimido trifluoromethane sulfonate.

6. The photoresist composition according to claim 1, wherein the photoacid generator is present in an amount ranging from 2 wt % to 10 wt % based on the weight of the photoresist polymer.

7. The photoresist composition according to claim 1, wherein the organic solvent is selected from the group consisting of methyl 3-methoxypropionate, ethyl 3-ethoxypropionate, propyleneglycol methylether acetate, cyclohexanone, 2-heptanone, ethyllactate, and mixtures thereof.

8. The photoresist composition according to claim 1, wherein the organic solvent is present in an amount ranging from 700 wt % to 4000 wt % based on the weight of the photoresist polymer.

9. A process for a photoresist pattern formation, the process comprising the steps of:
(a) coating the photoresist composition of claim 1 on a wafer to form a photoresist film;
(b) exposing the photoresist film to light; and,
(c) developing the exposed film to form a photoresist pattern.

10. The process according to claim 9, further comprising the steps of performing a soft baking step before the step (b) and a post baking process after the step (b).

11. The process according to claim 9, wherein the light source is selected from the group consisting of EUV, KrF, ArF, VUV, E-beam, X-beam, and ion beam.

12. A semiconductor device manufactured by the process according to claim 9.
